(19) United States
(12) Patent Application Publication
(10) Pub. No.: US 2013/0121188 A1
(43) Pub. Date: May 16, 2013

(54) METHOD AND APPARATUS FOR FREQUENCY OFFSET ESTIMATION

(71) Applicant: QUALCOMM INCORPORATED, San Diego, CA (US)

(72) Inventors: Sibasish Das, San Diego, CA (US); Shivratna Giri Srinivasan, San Diego, CA (US); Supratik Bhattacharjee, San Diego, CA (US); Brian Clarke Banister, San Diego, CA (US)

(73) Assignee: QUALCOMM INCORPORATED, San Diego, CA (US)

(21) Appl. No.: 13/671,877

(22) Filed: Nov. 8, 2012

Related U.S. Application Data
(60) Provisional application No. 61/558,334, filed on Nov. 10, 2011.

(51) Int. Cl. H04W 56/00

(52) U.S. Cl. CPC H04W 56/00
USPC 370/252

(57) ABSTRACT

Certain aspects of the present disclosure relate to a technique for estimating a frequency offset of a local oscillator using primary synchronization signal (PSS) and secondary synchronization signal (SSS) while initially acquiring a long term evolution (LTE) signal. In certain aspects, a frequency offset estimation procedure may include PSS-based frequency offset estimation and SSS-based frequency offset refinement. The PSS-based frequency offset estimation may include determining a suitable reference PSS and using the ascertained reference PSS to estimate a PSS-based frequency offset. The SSS-based frequency offset refinement may include determining a suitable reference SSS using the PSS based frequency offset and using the ascertained reference SSS to refine PSS-based frequency offset from the PSS-based frequency offset estimation.

The present application for patent claims priority to U.S. Provisional Application No. 61/558,334, entitled “METHOD AND APPARATUS FOR FREQUENCY OFFSET ESTIMATION,” filed Nov. 10, 2011, and assigned to the assignee hereof and hereby expressly incorporated by reference herein.

### BACKGROUND

1. Field

Certain aspects of the present disclosure generally relate to wireless communications and, more specifically, to a method and apparatus for frequency-offset estimation.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

Certain aspects of the present disclosure provide a method for wireless communication. The method generally includes detecting a primary synchronization sequence (PSS); calculating a PSS-based frequency offset by evaluating PSS-based SNR metrics generated for a plurality of frequency offset hypotheses based on the detected PSS; detecting a secondary synchronization sequence (SSS) using the PSS-based frequency offset; and calculating a joint frequency offset by evaluating SSS-based SNR metrics generated for the plurality of frequency offset hypotheses based on the detected SSS and the PSS-based SNR metrics.

Certain aspects of the present disclosure provide an apparatus for wireless communication. The apparatus generally includes means for detecting a primary synchronization sequence (PSS); means for calculating a PSS-based frequency offset by evaluating PSS-based SNR metrics generated for a plurality of frequency offset hypotheses based on the detected PSS; means for detecting a secondary synchronization sequence (SSS) using the PSS-based frequency offset; and means for calculating a joint frequency offset by evaluating SSS-based SNR metrics generated for the plurality of frequency offset hypotheses based on the detected SSS and the PSS-based SNR metrics.

Certain aspects of the present disclosure provide an apparatus for wireless communication. The apparatus generally includes at least one processor and a memory coupled to the at least one processor. The at least one processor is generally configured to detect a primary synchronization sequence (PSS); calculate a PSS-based frequency offset by evaluating PSS-based SNR metrics generated for a plurality of frequency offset hypotheses based on the detected PSS; detect a secondary synchronization sequence (SSS) using the PSS-based frequency offset; and calculate a joint frequency offset by evaluating SSS-based SNR metrics generated for the plurality of frequency offset hypotheses based on the detected SSS and the PSS-based SNR metrics.

Certain aspects of the present disclosure provide a computer program product for wireless communication. The computer program product generally includes a computer-readable medium having code for detecting a primary synchronization sequence (PSS); calculating a PSS-based frequency offset by evaluating PSS-based SNR metrics generated for a plurality of frequency offset hypotheses based on the detected PSS; detecting a secondary synchronization sequence (SSS) using the PSS-based frequency offset; and calculating a joint frequency offset by evaluating SSS-based SNR metrics generated for the plurality of frequency offset hypotheses based on the detected SSS and the PSS-based SNR metrics.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a Node B in communication with a user equipment device (UE) in a wireless communications network in accordance with certain aspects of the present disclosure.

FIG. 4 illustrates an example Primary Synchronization Signal (PSS) sequence and alternating Secondary Synchronization Signal (SSS) sequences with a periodicity of 5 ms, in accordance with certain aspects of the present disclosure.

FIG. 5 illustrates example operations that may be performed by a UE for initial frequency offset estimation in accordance with certain aspects of the present disclosure.

FIG. 5A illustrates example components capable of performing the operations illustrated in FIG. 5.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

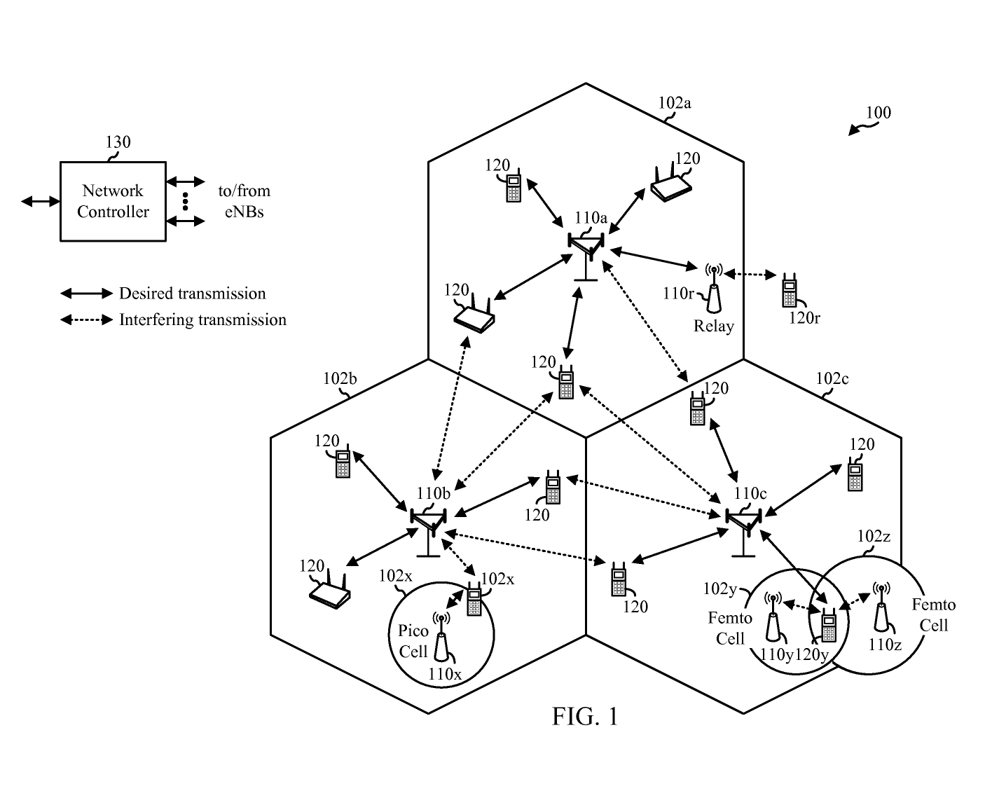

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. The term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

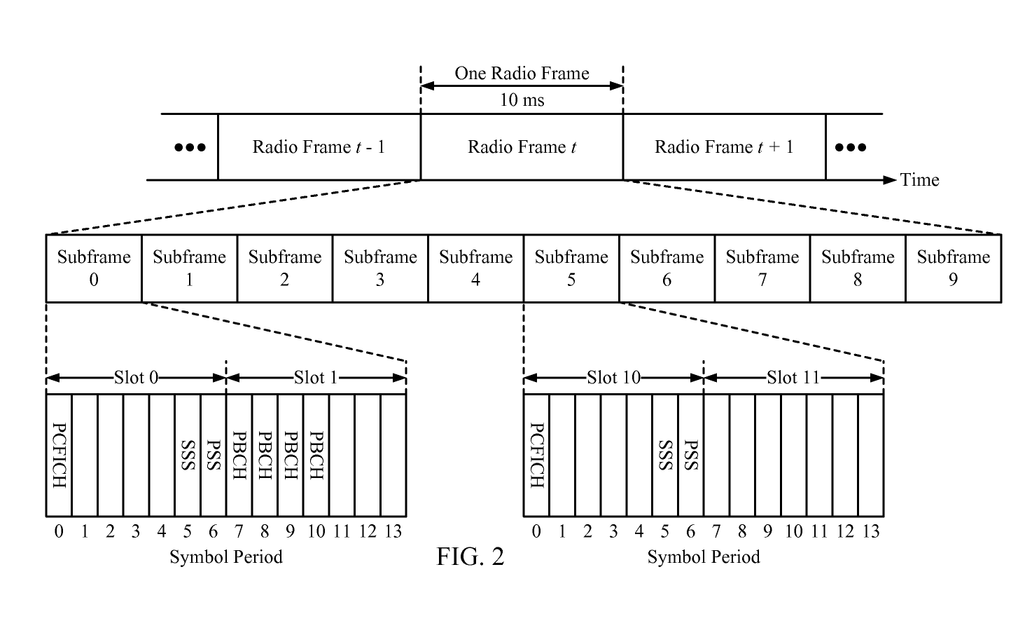

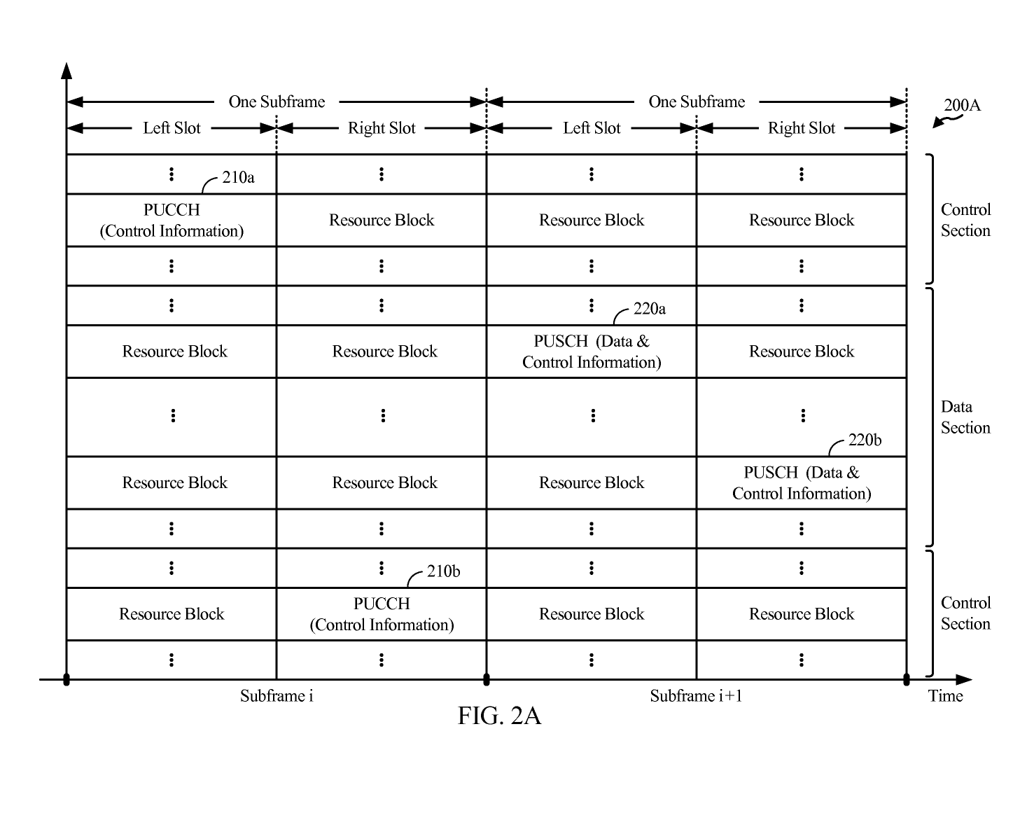

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP), as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the Node B. The UE may transmit control information in a Physical Uplink Control Channel (PUCCH) 210a, 210b on the assigned resource blocks in the control section. The UE may transmit data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, path loss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower path loss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the path loss for eNB 110x is lower than the path loss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the relative received power of signals from the eNB received at a UE (and not based on the transmit power level of the eNB).

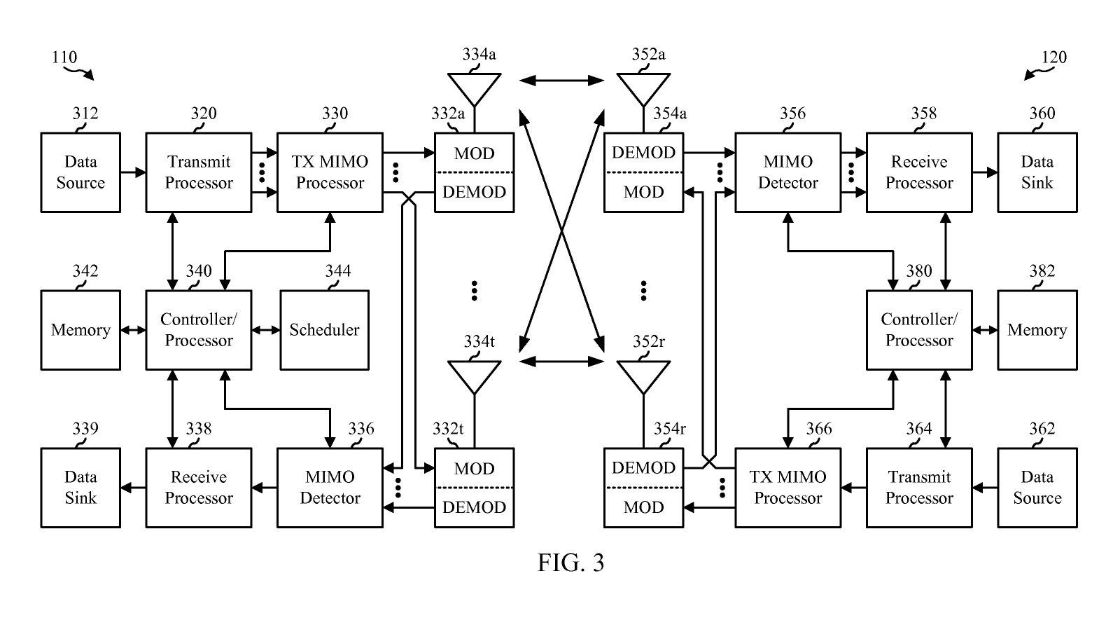

FIG. 3 shows a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and UE 120 may be UE 120y. The eNB 110 may also be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by antennas 334, processed by demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340, 380 may direct the operation at the eNB 110 and the UE 120, respectively. The controller/processor 380 and/or other processors and modules at the UE 120 may perform or direct operations for blocks 800 in FIG. 8, operations for blocks 1000 in FIG. 10, operations for blocks 1100 in FIG. 11, and/or other processes for the techniques described herein. The memories 342 and 382 may store data and program codes for base station 110 and UE 120, respectively. A scheduler 344 may schedule UEs for data transmission on the downlink and/or uplink.

In LTE, cell identities range from 0 to 503. Synchronization signals are transmitted in the center 62 resource elements (REs) around the DC tone to help detect cells. The synchronization signals comprise two parts: a Primary Synchronization Signal (PSS) and a Secondary Synchronization Signal (SSS).

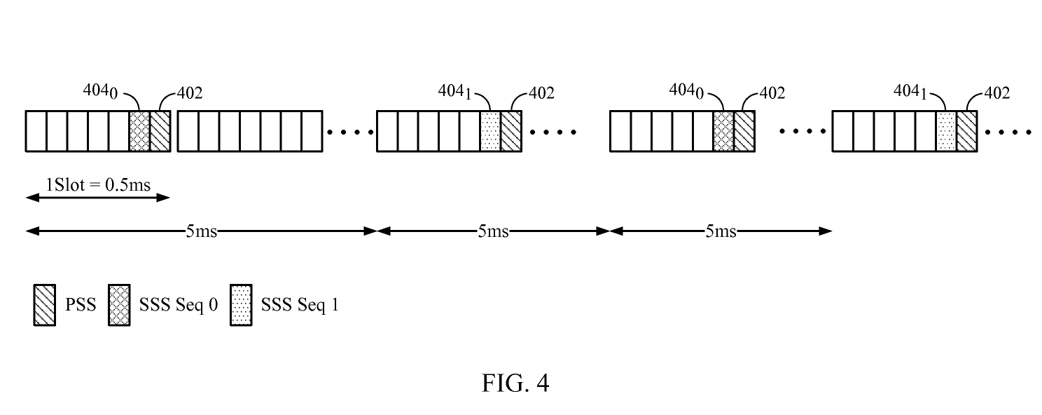

FIG. 4 illustrates an example PSS sequence 402 and alternating SSS sequences 404₀, 404₁ with a periodicity of 5 ms, in accordance with certain aspects of the present disclosure. The PSS allows a UE to obtain frame timing modulo 5 ms and part of the physical layer cell identifier (cell ID), and specifically cell id modulo 3. Three different PSS sequences exist with each sequence mapping to a disjoint group of 168 cell IDs. Based on Zadoff-Chu (ZC) sequences, the PSS sequence is chosen from one of 3 sequences based on a PSS Index=Cell ID modulo 3. The same sequence is transmitted every 5 ms as shown in FIG. 4.

The SSS is used by the UE to detect the LTE frame timing modulo 10 ms and to obtain the cell ID. The SSS is transmitted twice in each 10 ms radio frame as depicted in FIG. 4. The SSS sequences are based on maximum length sequences, known as M-sequences, and each SSS sequence is constructed by interleaving, in the frequency-domain, two length-31 Binary Phase Shift Keying (BPSK)-modulated sequences. These two codes are two different cyclic shifts of a single length-31 M-sequence. The cyclic shift indices of the M-sequences are derived from a function of the physical layer cell identity group. The two codes are alternated between the first and second SSS transmissions in each radio frame.

In other words, two sequences for a cell ID that alternate every 5 ms are transmitted. The SSS sequence is obtained by first choosing from a set of 168 different sequences (different sets for subframes 0 and 5) based on an SSS Index (=floor(Cell ID/3)) and then scrambling the chosen sequence using a sequence which is a function of the PSS Index. Hence, while searching for the SSS, if the PSS Index is known, a UE may only need to search up to 168 sequences.

Spacing between the PSS and the SSS helps a UE to distinguish between Extended Cyclic Prefix (CP) and Normal CP modes and between TDD (Time Division Duplex) and FDD (Frequency Division Duplex) modes.

A typical searching operation may involve first locating the PSS sequences transmitted by neighboring eNBs (i.e., determining the timing and the PSS index), followed by SSS detection for the found PSS Index around the determined timing.

### Example Frequency Offset Estimation

According to certain aspects, a frequency offset may need to be estimated (e.g., by a UE) due to imperfections in the local oscillator during the process of initially acquiring an LTE signal with a certain center frequency on a band of interest. In an aspect, the frequency offset estimation may use the PSS and the SSS transmitted by an eNodeB.

In certain aspects, a frequency offset estimation procedure may include PSS-based frequency offset estimation and SSS-based frequency offset refinement. The PSS-based frequency offset estimation may broadly include determining a suitable reference PSS and using the ascertained reference PSS to estimate a PSS-based frequency offset. The SSS-based frequency offset refinement may broadly include determining a suitable reference SSS using the PSS based frequency offset and using the ascertained reference SSS to refine PSS-based frequency offset from the PSS-based frequency offset estimation.

### PSS-Based Frequency Offset Estimation

The PSS-based frequency offset estimation may start with determining a suitable PSS and extracting the samples corresponding to the OFDM symbol carrying the PSS. In an aspect, Nf equally spaced frequency offset hypotheses that span the uncertainty of the oscillator may be considered for the frequency offset estimation. For each frequency-offset hypothesis, a frequency offset equal to the frequency offset hypothesis may be removed by appropriately modulating the samples, and the modulated samples may be correlated against the reference PSS sequence. Energy may be calculated and combined across receive antennas. A hypothesis corresponding to the maximum of the energies calculated may be selected. The selected frequency-offset hypothesis may then be used to estimate a noise variance corrupting the OFDM symbol carrying the PSS.

The energy calculated for each frequency-offset hypothesis may then be normalized using the estimated noise variance to generate a signal-to-noise ratio (SNR) metric for each receive antenna. For each frequency-offset hypothesis, the SNR metric may be accumulated across receive antennas. A winning frequency-offset hypothesis may be chosen corresponding to the maximum accumulated SNR metric.

In certain aspects, it may be determined if a winning frequency offset hypothesis corresponding to the selected PSS-based frequency offset is an edge hypothesis. In an aspect, if the winning frequency-offset hypothesis is not an edge hypothesis, quadratic interpolation may be applied on the accumulated SNR metrics for the maximum frequency-offset hypothesis, and its two neighboring frequency-offset hypotheses to obtain the PSS-based frequency-offset estimate. However, if the winning frequency-offset hypothesis is an edge hypothesis, the winning frequency-offset hypothesis may be selected as the PSS-based frequency-offset estimate.

### SSS-Based Frequency Offset Refinement

The SSS-based frequency offset refinement may begin by determining a suitable SSS using the PSS based frequency offset. Once a suitable SSS has been determined, the samples corresponding to the OFDM symbol carrying the SSS may be determined. For each of the Nf frequency offset hypothesis (same as used in the PSS-based frequency offset estimation), a frequency offset equal to the frequency offset hypothesis may be removed by appropriately modulating the samples, and the modulated samples may be correlated against the reference SSS sequence. Energy may be calculated and combined across receive antennas. A hypothesis corresponding to the maximum of the energies calculated may be selected. The selected frequency-offset hypothesis may then be used to estimate a noise variance corrupting the OFDM symbol carrying the SSS.

The energy calculated for each frequency-offset hypothesis may then be normalized using the estimated noise variance to generate a signal-to-noise ratio (SNR) metric for each receive antenna. For each frequency-offset hypothesis, the SNR metric may be accumulated across receive antennas.

In an aspect, for each frequency offset hypothesis, the SSS-based accumulated SNR metric may be combined with the PSS-based accumulated SNR metric (from the PSS-based frequency offset estimation) to obtain a joint SNR metric. In an aspect, a winning frequency offset hypothesis corresponding to a maximum joint SNR metric is chosen.

In certain aspects, it may be determined if a winning frequency offset hypothesis corresponding to the selected SSS-based frequency offset is an edge hypothesis. In an aspect, if the winning frequency-offset hypothesis is not an edge hypothesis, quadratic interpolation may be applied on the accumulated SNR metrics for the maximum frequency-offset hypothesis, and at least its two neighboring frequency-offset hypotheses to obtain the PSS-based frequency-offset estimate. However, if the winning frequency-offset hypothesis is an edge hypothesis, the winning frequency-offset hypothesis may be selected as the PSS-based frequency-offset estimate.

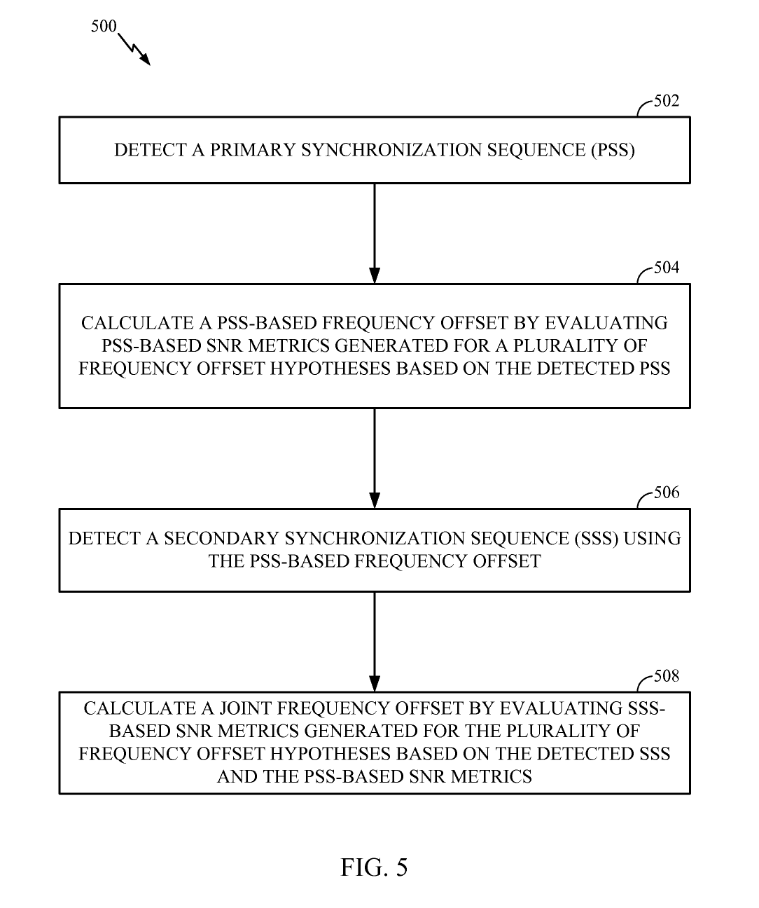

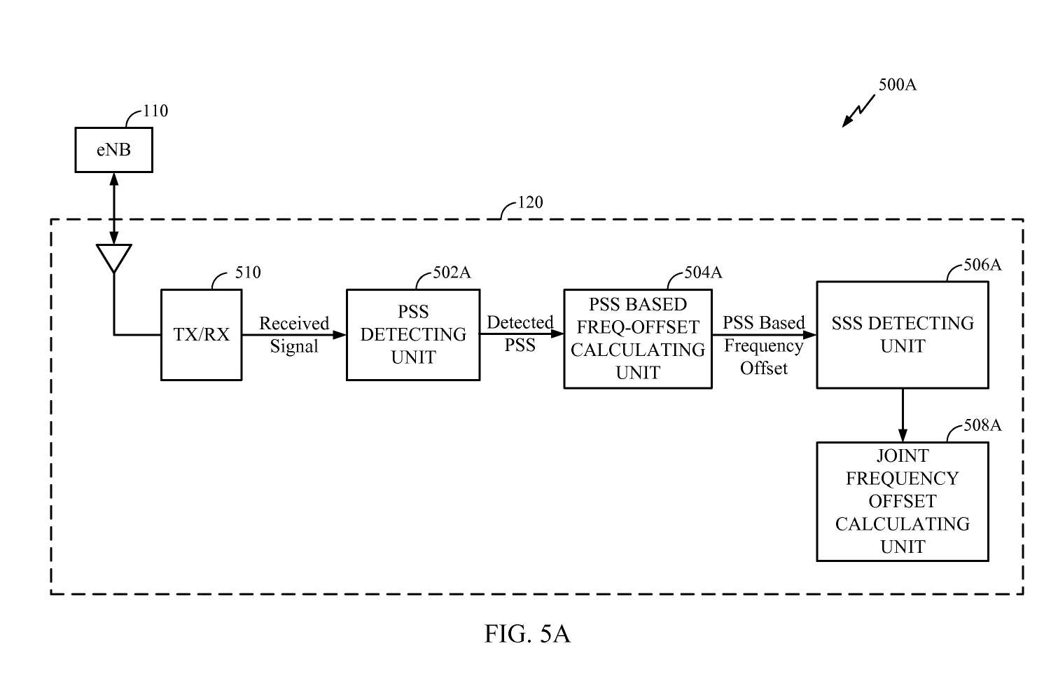

FIG. 5 illustrates example operations 500 that may be performed by a UE for initial frequency offset estimation in accordance with certain aspects of the present disclosure. Operations 500 may start, at 502, by detecting a primary synchronization sequence (PSS). At 504, a PSS-based frequency offset may be calculated by evaluating PSS-based SNR metrics generated for a plurality of frequency offset hypotheses based on the detected PSS. At 506, a secondary synchronization sequence (SSS) may be detected using the PSS-based frequency offset. At 508, a joint frequency offset may be calculated by evaluating SSS-based SNR metrics generated for the plurality of frequency offset hypotheses based on the detected SSS and the PSS-based SNR metrics.

The operations 500 described above may be performed by any suitable components or other means capable of performing the corresponding functions of FIG. 5. For example, operations 500 illustrated in FIG. 5 correspond to components 500A illustrated in FIG. 5A. In FIG. 5A, a transceiver (TX/RX) 510 may receive a signal from an eNB 110 of a cell. A PSS detecting unit 502A may detect a primary synchronization sequence (PSS). A PSS-based frequency offset calculating unit 504A may calculate a PSS-based frequency offset by evaluating PSS-based SNR metrics generated for a plurality of frequency offset hypotheses based on the detected PSS. A SSS detecting unit may detect a secondary synchronization sequence (SSS) using the PSS-based frequency offset. A joint frequency offset calculating unit 508A may calculate a joint frequency offset by evaluating SSS-based SNR metrics generated for the plurality of frequency offset hypotheses based on the detected SSS and the PSS-based SNR metrics.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for transmitting or means for sending may comprise a transmitter, a modulator 354, and/or an antenna 352 of the UE 120 depicted in FIG. 3 or a transmitter, a modulator 332, and/or an antenna 334 of the eNB 110 shown in FIG. 3. Means for receiving may comprise a receiver, a demodulator 354, and/or an antenna 352 of the UE 120 depicted in FIG. 3 or a receiver, a demodulator 332, and/or an antenna 334 of the eNB 110 shown in FIG. 3. Means detecting and means for calculating may comprise a processing system, which may include at least one processor, such as the transmit processor 320, the receive processor 338, or the controller/processor 340 of the eNB 110 or the receive processor 358, the transmit processor 364, or the controller/processor 380 of the UE 120 illustrated in FIG. 3.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communication, comprising:
detecting a primary synchronization sequence (PSS);
calculating a PSS-based frequency offset by evaluating PSS-based SNR metrics generated for a plurality of frequency offset hypotheses based on the detected PSS;
detecting a secondary synchronization sequence (SSS) using the PSS-based frequency offset; and
calculating a joint frequency offset by evaluating SSS-based SNR metrics generated for the plurality of frequency offset hypotheses based on the detected SSS and the PSS-based SNR metrics.

2. The method of claim 1, wherein calculating the PSS-based frequency offset comprises:
calculating, for each of the plurality of frequency offset hypotheses, PSS energy as energy in the detected PSS;
estimating a PSS-based noise variance based on a frequency offset hypothesis corresponding to the maximum PSS energy;
calculating the PSS-based SNR metric for each of the frequency offset hypotheses, based on PSS energy normalized using the PSS-based estimated noise variance; and
selecting, as the PSS-based frequency offset, a frequency offset hypothesis corresponding to a maximum SNR metric.

3. The method of claim 1, wherein calculating the joint frequency offset comprises:
calculating, for each of the plurality of frequency offset hypotheses, SSS energy as energy in the detected SSS;
estimating an SSS-based noise variance based on a frequency offset hypothesis corresponding to the maximum SSS energy;
calculating the SSS-based SNR metric for each of the frequency offset hypotheses, based on SSS energy normalized using the SSS-based estimated noise variance;
combining, for each frequency offset hypothesis, the SSS-based SNR metric and the PSS-based SNR metric to obtain a joint SNR metric; and
selecting, as the joint frequency offset, a frequency offset hypothesis corresponding to a maximum joint SNR metric.

4. The method of claim 2, wherein calculating the PSS-based SNR metric for each of the frequency offset hypotheses comprises:
calculating a PSS-based SNR metric for each of a plurality of receive antennas; and
accumulating the PSS-based SNR metric across receive antennas for each frequency-offset hypothesis.

5. The method of claim 3, wherein calculating the SSS-based SNR metric for each of the frequency offset hypotheses comprises:
calculating a SSS-based SNR metric for each of a plurality of receive antennas; and
accumulating the SSS-based SNR metric across receive antennas for each frequency-offset hypothesis.

6. The method of claim 1, further comprising:
determining if a frequency offset hypothesis corresponding to the selected PSS-based frequency offset comprises an edge hypothesis; and
if not, applying quadratic interpolation on the PSS based SNR metrics for the maximum frequency-offset hypothesis, and at least two neighboring frequency-offset hypotheses to obtain the PSS-based frequency-offset.

7. The method of claim 1, further comprising:
determining if a frequency offset hypothesis corresponding to the joint frequency offset comprises an edge hypothesis; and
if not, applying quadratic interpolation on the joint SNR metrics for the maximum frequency-offset hypothesis, and at least two neighboring frequency-offset hypotheses to obtain the PSS-based frequency-offset.

8. An apparatus for wireless communication, comprising:
means for detecting a primary synchronization sequence (PSS);
means for calculating a PSS-based frequency offset by evaluating PSS-based SNR metrics generated for a plurality of frequency offset hypotheses based on the detected PSS;
means for detecting a secondary synchronization sequence (SSS) using the PSS-based frequency offset; and
means for calculating a joint frequency offset by evaluating SSS-based SNR metrics generated for the plurality of frequency offset hypotheses based on the detected SSS and the PSS-based SNR metrics.

9. The apparatus of claim 8, wherein the means for calculating the PSS-based frequency offset comprises:
means for calculating, for each of the plurality of frequency offset hypotheses, PSS energy as energy in the detected PSS;
means for estimating a PSS-based noise variance based on a frequency offset hypothesis corresponding to the maximum PSS energy;
means for calculating the PSS-based SNR metric for each of the frequency offset hypotheses, based on PSS energy normalized using the PSS-based estimated noise variance; and
means for selecting, as the PSS-based frequency offset, a frequency offset hypothesis corresponding to a maximum SNR metric.

10. The apparatus of claim 8, wherein the means for calculating the joint frequency offset comprises:
means for calculating, for each of the plurality of frequency offset hypotheses, SSS energy as energy in the detected SSS;
means for estimating an SSS-based noise variance based on a frequency offset hypothesis corresponding to the maximum SSS energy;
means for calculating the SSS-based SNR metric for each of the frequency offset hypotheses, based on SSS energy normalized using the SSS-based estimated noise variance;
means for combining, for each frequency offset hypothesis, the SSS-based SNR metric and the PSS-based SNR metric to obtain a joint SNR metric; and
means for selecting, as the joint frequency offset, a frequency offset hypothesis corresponding to a maximum joint SNR metric.

11. The apparatus of claim 9, wherein the means for calculating the PSS-based SNR metric for each of the frequency offset hypotheses comprises:
means for calculating a PSS-based SNR metric for each of a plurality of receive antennas; and
means for accumulating the PSS-based SNR metric across receive antennas for each frequency-offset hypothesis.

12. The apparatus of claim 10, wherein the means for calculating the SSS-based SNR metric for each of the frequency offset hypotheses comprises:
means for calculating a SSS-based SNR metric for each of a plurality of receive antennas; and
means for accumulating the SSS-based SNR metric across receive antennas for each frequency-offset hypothesis.

13. The apparatus of claim 8, further comprising:
means for determining if a frequency offset hypothesis corresponding to the selected PSS-based frequency offset comprises an edge hypothesis; and
means for applying quadratic interpolation on the PSS based SNR metrics for the maximum frequency-offset hypothesis, and at least two neighboring frequency-offset hypotheses to obtain the PSS-based frequency-offset, if the frequency offset hypothesis corresponding to the selected PSS-based frequency offset does not comprise an edge hypothesis.

14. The apparatus of claim 8, further comprising:
means for determining if a frequency offset hypothesis corresponding to the joint frequency offset comprises an edge hypothesis; and
means for applying quadratic interpolation on the joint SNR metrics for the maximum frequency-offset hypothesis, and at least two neighboring frequency-offset hypotheses to obtain the PSS-based frequency-offset, if the frequency offset hypothesis corresponding to the joint frequency offset does not comprise an edge hypothesis.

15. An apparatus for wireless communication, comprising:
at least one processor configured to;
detect a primary synchronization sequence (PSS);
calculate a PSS-based frequency offset by evaluating PSS-based SNR metrics generated for a plurality of frequency offset hypotheses based on the detected PSS;
detect a secondary synchronization sequence (SSS) using the PSS-based frequency offset; and
calculate a joint frequency offset by evaluating SSS-based SNR metrics generated for the plurality of frequency offset hypotheses based on the detected SSS and the PSS-based SNR metrics; and
a memory coupled to the at least one processor.

16. The apparatus of claim 15, wherein the at least one processor is configured to calculate the PSS-based frequency offset by:
calculating, for each of the plurality of frequency offset hypotheses, PSS energy as energy in the detected PSS;
estimating a PSS-based noise variance based on a frequency offset hypothesis corresponding to the maximum PSS energy;
calculating the PSS-based SNR metric for each of the frequency offset hypotheses, based on PSS energy normalized using the PSS-based estimated noise variance; and
selecting, as the PSS-based frequency offset, a frequency offset hypothesis corresponding to a maximum SNR metric.

17. The apparatus of claim 15, wherein the at least one processor is configured to calculate the joint frequency offset by:
calculating, for each of the plurality of frequency offset hypotheses, SSS energy as energy in the detected SSS;
estimating an SSS-based noise variance based on a frequency offset hypothesis corresponding to the maximum SSS energy;
calculating the SSS-based SNR metric for each of the frequency offset hypotheses, based on SSS energy normalized using the SSS-based estimated noise variance;
combining, for each frequency offset hypothesis, the SSS-based SNR metric and the PSS-based SNR metric to obtain a joint SNR metric; and
selecting, as the joint frequency offset, a frequency offset hypothesis corresponding to a maximum joint SNR metric.

18. The apparatus of claim 16, wherein the at least one processor is configured to calculate the PSS-based SNR metric for each of the frequency offset hypotheses by:
calculating a PSS-based SNR metric for each of a plurality of receive antennas; and
accumulating the PSS-based SNR metric across receive antennas for each frequency-offset hypothesis.

19. The apparatus of claim 17, wherein the at least one processor is configured to calculate the SSS-based SNR metric for each of the frequency offset hypotheses by:
calculating a SSS-based SNR metric for each of a plurality of receive antennas; and
accumulating the SSS-based SNR metric across receive antennas for each frequency-offset hypothesis.

20. The apparatus of claim 15, wherein the at least one processor is further configured to:
determine if a frequency offset hypothesis corresponding to the selected PSS-based frequency offset comprises an edge hypothesis; and
if not, apply quadratic interpolation on the PSS based SNR metrics for the maximum frequency-offset hypothesis, and at least two neighboring frequency-offset hypotheses to obtain the PSS-based frequency-offset.

21. The apparatus of claim 15, wherein the at least one processor is further configured to:
determine if a frequency offset hypothesis corresponding to the joint frequency offset comprises an edge hypothesis; and
if not, apply quadratic interpolation on the joint SNR metrics for the maximum frequency-offset hypothesis, and at least two neighboring frequency-offset hypotheses to obtain the PSS-based frequency-offset.

22. A computer program product for wireless communication, comprising:
a computer-readable medium comprising code for:
detecting a primary synchronization sequence (PSS);
calculating a PSS-based frequency offset by evaluating PSS-based SNR metrics generated for a plurality of frequency offset hypotheses based on the detected PSS;
detecting a secondary synchronization sequence (SSS) using the PSS-based frequency offset; and
calculating a joint frequency offset by evaluating SSS-based SNR metrics generated for the plurality of frequency offset hypotheses based on the detected SSS and the PSS-based SNR metrics.

23. The computer program product of claim 22, wherein the code for calculating the PSS-based frequency offset comprises code for:
calculating, for each of the plurality of frequency offset hypotheses, PSS energy as energy in the detected PSS;
estimating a PSS-based noise variance based on a frequency offset hypothesis corresponding to the maximum PSS energy;
calculating the PSS-based SNR metric for each of the frequency offset hypotheses, based on PSS energy normalized using the PSS-based estimated noise variance; and
selecting, as the PSS-based frequency offset, a frequency offset hypothesis corresponding to a maximum SNR metric.

24. The computer program product of claim 22, wherein the code for calculating the joint frequency offset comprises code for:
calculating, for each of the plurality of frequency offset hypotheses, SSS energy the detected SSS;
estimating an SSS-based noise variance based on a frequency offset hypothesis corresponding to the maximum SSS energy;
calculating the SSS-based SNR metric for each of the frequency offset hypotheses, based on SSS energy normalized using the SSS-based estimated noise variance;
combining, for each frequency offset hypothesis, the SSS-based SNR metric and the PSS-based SNR metric to obtain a joint SNR metric; and
selecting, as the joint frequency offset, a frequency offset hypothesis corresponding to a maximum joint SNR metric.

25. The computer program product of claim 23, wherein the code for calculating the PSS-based SNR metric for each of the frequency offset hypotheses comprises code for:
calculating a PSS-based SNR metric for each of a plurality of receive antennas; and
accumulating the PSS-based SNR metric across receive antennas for each frequency-offset hypothesis.

26. The computer program product of claim 24, wherein the code for calculating the SSS-based SNR metric for each of the frequency offset hypotheses comprises code for:
calculating a SSS-based SNR metric for each of a plurality of receive antennas; and
accumulating the SSS-based SNR metric across receive antennas for each frequency-offset hypothesis.

27. The computer program product of claim 22 further comprising code for:
determining if a frequency offset hypothesis corresponding to the selected PSS-based frequency offset comprises an edge hypothesis; and
if not, applying quadratic interpolation on the PSS based SNR metrics for the maximum frequency-offset hypothesis, and at least two neighboring frequency-offset hypotheses to obtain the PSS-based frequency-offset.

28. The computer program product of claim 22, further comprising code for:
determining if a frequency offset hypothesis corresponding to the joint frequency offset comprises an edge hypothesis; and
if not, applying quadratic interpolation on the joint SNR metrics for the maximum frequency-offset hypothesis, and at least two neighboring frequency-offset hypotheses to obtain the PSS-based frequency-offset.
